(19) United States
(12) Patent Application Publication
(10) Pub. No.: US 2011/0259363 A1
(43) Pub. Date: Oct. 27, 2011

(54) PROCESS FOR REMOVING A COATING FROM SURFACES OF COMPONENTS USING ONLY HYDROCHLORIC ACID

(75) Inventors: Jens Birkner, Oberhausen (DE); Jan Steinbach, Berlin (DE); Rolf Wilkenhöner, Kleinmachnow (DE)

(73) Assignee: SIEMENS AKTIENGESELLSCHAFT, Muenchen (DE)

(21) Appl. No.: 13/127,325

(22) PCT Filed: Sep. 10, 2009
(86) PCT No.: PCT/EP2009/061745

§ 371 Date: Jul. 13, 2011

(30) Foreign Application Priority Data
Nov. 5, 2008 (EP) 08019364.2

(51) Int. Cl. C23G 1/02; B08B 3/10

(52) U.S. Cl. 134/3

(57) ABSTRACT

The removal of a coating from components after they have been used is often achieved using various acid baths and salt melts. A coating removal process that includes only using hydrochloric acid is provided. The duration of the process in which the coating is treated with the hydrochloric acids has a duration of between 2 and 2.5 hours. The process includes treated the coating with the hydrochloric acid at least twice.

### CROSS REFERENCE TO RELATED APPLICATIONS

This application is the US National Stage of International Application No. PCT/EP2009/061745, filed Sep. 10, 2009 and claims the benefit thereof. The International Application claims the benefits of European Patent Office application No. 08019364.2 EP filed Nov. 5, 2002. All of the applications are incorporated by reference herein in their entirety.

### FIELD OF INVENTION

The invention relates to a process for removing a coating from surfaces of components.

### BACKGROUND OF INVENTION

The cleaning of and removal of a coating from the inner, but also the outer surface of gas turbine blades or vanes during refurbishment is an important requirement for subsequent repair processes, for example during soldering or welding. If too many oxidic residues or residual layers of the original inner or outer alitization which contain a relatively large quantity of aluminum remain on the surface of the component, the subsequent crack cleaning process (HF cleaning or FIC) cannot penetrate into the crack tips, since too much process gas is consumed for converting the surface oxides and residual layers which have remained. This is problematic particularly on the inner surface of the component, since said surface is largely inaccessible for conventional mechanical blasting processes and therefore the oxide layer produced during operation on the inner alitization cannot be damaged mechanically or removed. According to an existing assumption, this in turn restricts the access of chemical etchants to diffusion zones which contain a relatively large quantity of aluminum.

The process applied, which consists of a combination of a molten salt bath and acid bath cleaning, chemically cleans the inner surface initially by basic digestion of the oxides in strong alkaline solutions and then by acidic digestion of the diffusion zone of the inner alitization which contains a large quantity of aluminum only partially or inadequately. In total, three different wet-chemical processes with hot, highly concentrated salt solutions, bases and acids with different flushing and drying procedures are required.

### SUMMARY OF INVENTION

It is therefore an object of the invention to simplify the problem mentioned above in an economic and technical respect.

The object is achieved by a process as claimed in the claims, in which process only hydrochloric acid is used.

The dependent claims list further advantageous measures which can be combined with one another, as desired, in order to achieve further advantages.

### BRIEF DESCRIPTION OF THE DRAWINGS

FIG. 1 shows a list of superalloys, and

FIG. 2 shows a turbine blade or vane.

The invention is explained in more detail with reference to examples.

### DETAILED DESCRIPTION OF INVENTION

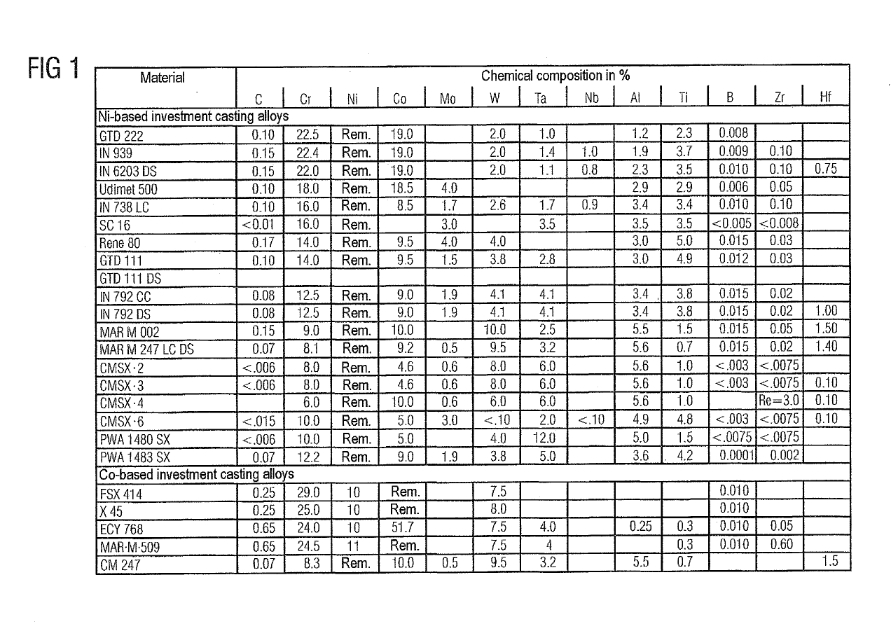

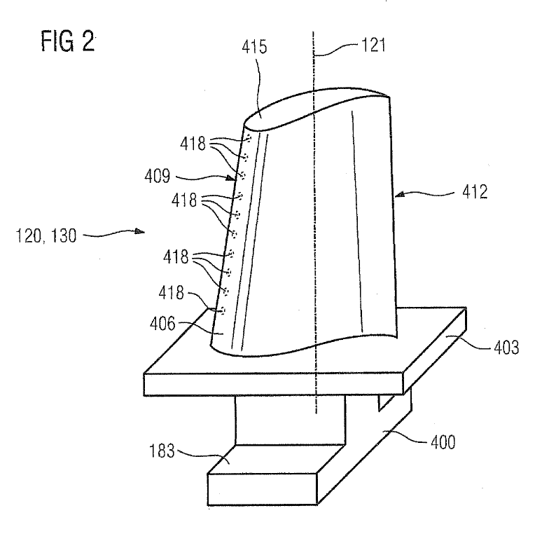

The interior of turbine blades or vanes 120, 130 (FIG. 2) consisting of nickel- or cobalt-based superalloys (FIG. 1) is often also alitized so that said blades or vanes are protected in their interior, since the interior of the turbine blade or vane 120, 130 is cooled by means of hot steam. The alitization represents for the most part or completely a diffusion layer.

During the refurbishment, it is expedient to remove the alitization, so that a new alitization can be carried out or so as to simply remove damaged layer regions.

According to the invention, the interior or in general terms the surface is cleaned using only hydrochloric acid and not using an acid mixture, or else not with the use of or pretreatment by means of fused salts (KOH, NaOH). Similarly, no FIC cleaning is carried out to remove the alitization.

The concentration of the hydrochloric acid (HCl) is preferably 15% to 30% and very preferably 20% to 25%. The proportion of HCl is preferably calculated in % by weight.

The acid treatment is preferably carried out up to eight times, in particular at least twice. The acid treatment is preferably carried out twice to 6 times and very preferably 3 to 4 times.

This depends on the alitization and the service life of the component 120, 130.

The treatment duration in the acid bath is in particular at least 2 hours, in particular 2 to 2.5 hours.

The sole etching in hydrochloric acid means that two process steps which involve a large amount of energy and chemicals are eliminated from the existing process. The inner cleaning can even advantageously take place at the same time as the outer cleaning (removal of an MCrAlY coating), and this provides additional synergies.

In particular, a mechanical blasting process can precede the chemical etching process or can be used between the two acid treatments of the chemical etching.

This preferably involves inner vacuum blasting (abrasive agent is sucked by reduced air pressure through the cavities in the component) or an abrasive, low-viscosity fluid flowing through the component (for example water jet cleaning with abrasive particles). Similarly, watering preferably takes place between the acid treatments.

During operation, the inner alitization has already suffered a sufficient amount of damage (e.g. cracks, spalling, etc.). This damage represents points at which the acid can attack. At such damaged locations, the acid can also get behind still intact points of the inner alitization so that the latter are detached from the substrate (nickel superalloy) and drop off.

The temperature of the hydrochloric acid bath is preferably at least room temperature, very preferably 60° C. to 70° C.

Here, “acid treatment” is understood to mean the residence time of the component in the acid bath until it is removed and, for example, watered, internally blasted, inspected (degree of coating removal) etc. or immersed in a new, fresh acid bath.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1.-11. (canceled)

12. A process for removing a coating from an alitized surface, comprising:
chemically treating an alitized surface region with only hydrochloric acid; and
carrying out the treatment with the hydrochloric acid for 2 hours to 2.5 hours,
wherein the acid treatment is carried out at least twice.

13. The process as claimed in claim 12, wherein the alitized surface is an inner surface of a component.

14. The process as claimed in claim 13, wherein the component is a turbine blade or vane.

15. The process as claimed in claim 12, wherein the acid treatment is carried out at least three times.

16. The process as claimed in claim 12, wherein a concentration of the hydrochloric acid is between 15% and 30%.

17. The process as claimed in claim 16, wherein the concentration is between 20% and 25%.

18. The process as claimed in claim 12, wherein the acid treatment is carried out up to eight times.

19. The process as claimed in claim 18, wherein which the acid treatment is carried out twice to 6 times.

20. The process as claimed in claim 19, where the acid treatment is carried out 3 or 4 times.

21. The process as claimed in claim 18, wherein an intermediate cleaning is carried out between the acid treatments.

22. The process as claimed in claim 12, wherein a coating is removed from turbine blades or vanes.

23. The process as claimed in claim 22, wherein the turbine blades or vanes are internally alitized blades or vanes.

24. The process as claimed in claim 21, wherein a mechanical process is carried out as the intermediate cleaning.

25. The process as claimed in claim 24, wherein the mechanical process is a blasting process.

26. The process as claimed in claim 12, wherein the alitized surface represents an alitized nickel- or cobalt-based superalloy.

27. The process as claimed in claim 12, wherein a temperature of the hydrochloric acid is 60° C. to 70° C.

28. The process as claimed in claim 12, wherein which the turbine component includes a nickel-based substrate.

29. The process as claimed in claim 22, wherein no fused salt is used for the removal of the coating.
